(19) United States
(12) Patent Application Publication
(10) Pub. No.: US 2015/0193085 A1
(43) Pub. Date: Jul. 9, 2015

(54) OBJECT TRACKING SYSTEM AND METHOD

(71) Applicant: Radion Engineering Co. Ltd., Petach-Tikva (IL)

(72) Inventors: Uri Talmor, Ramat-HaSharon (IL); Gal Oz, Kfar-Saba (IL); Sharon Ehrlich, Kfar-Vitkin (IL)

(21) Appl. No.: 14/413,446

(22) PCT Filed: Jul. 9, 2013
(86) PCT No.: PCT/IL13/50585

§ 371 Date: Jan. 8, 2015

Related U.S. Application Data
(60) Provisional application No. 61/669,141, filed on Jul. 9, 2012.

(51) Int. Cl. G06F 3/042; G06F 3/041; G06F 3/01

(52) U.S. Cl. CPC G06F 3/0421; G06F 3/017; G06F 3/0412; G06F 2203/04101; G06F 2203/04104; G06F 2203/04106; G06F 2203/04108; G06F 2203/04109

(57) ABSTRACT

User interface apparatus for a computer system, comprises: a touch surface having an internal face and a touch face; cameras placed about said touch face and arranged to image the touch face including the surface itself and a volume extending outwardly from the surface on the touch face; and an illumination unit that illuminates the touch side. The illumination unit illuminates separately a) a relatively thin first volume close to the touch surface for touch control—the touch volume, and b) a relatively deep second volume extending away from the first volume for three-dimensional hand or body gesture control— the depth volume, the separate illuminating providing for separate imaging by the cameras of the touch and depth volumes.

### RELATED APPLICATION

This application claims the benefit of priority under 35 USC §119(e) of U.S. Provisional Patent Application No. 61/669,141 filed Jul. 9, 2012, the contents of which are incorporated herein by reference in their entirety.

### FIELD AND BACKGROUND OF THE INVENTION

The present invention, in some embodiments thereof, relates to an object tracking system and method and a user interface using the same, and, more particularly, but not exclusively, to touch control surfaces and to three-dimensional tracking volumes.

Touchscreens and 3D trackers are effective user interfaces. Touchscreens in particulars are today ubiquitous on smartphones. However they are much less used on larger screens, because their complexity and thus both manufacturing cost and liability to failure, increase with the square of the screen size.

Large size touchscreens however, do exist. One example is disclosed in International Patent Application No. WO2010/116308, in which an array of cameras is placed behind a screen and near infra-red (NIR) LEDs uniformly illuminate the region of the surface of the screen. The cameras are arranged to provide full coverage of the screen area, and overlapping regions are discounted. Thus each camera sees a complete square and each point on the screen is seen by a single camera.

3D tracking systems also exist. Optical 3D tracking systems illuminate a volume with a differential illumination pattern. The regions in 3D space—voxels—are tracked such that each point is seen by two cameras.

Optical touchscreens and optical 3D tracking systems are mutually exclusive since one requires a single camera per point and uniform illumination and the other requires multiple cameras per point and differential illumination.

### SUMMARY OF THE INVENTION

The present embodiments provide an optical tracking system that supports both touchscreen and 3D depth tracking using the same infrastructure. The present embodiments further provide a system for imaging through an LCD screen from behind the LCD illumination infrastructure.

An embodiment of the present invention is a new system and method on controlling applications, systems and machine using a 3D tracking area above or in front of a screen.

The embodiment covers the method of the 3D tracking and the implementation and behavior on different applications and systems.

Control may be with the hands, fingers or a pointing device such as for example a stylus. The control can be also triggered by any other object as required by a currently active application as the system can capture any object that is covered in the volume and/or the surface.

Conventional systems for user interface include touch screens that give the user an ability to control the application with fingers that move over the surface of the screen. Other user interface systems may give the user the ability to control the application from a distance of meters or centimeters but not including being in contact with the screen, by reading finger positions and gestures in a three-dimensional volume.

The present embodiments give the user the ability to control the application by moving hands or pointing devices both on the surface itself and within a 3D volume beyond the surface, up to a distance which may for example be about 2 meters.

According to an aspect of some embodiments of the present invention there is provided user interface apparatus for a computer system, comprising:

a touch surface having an internal side and a touch side;

a plurality of cameras placed about the touch surface and arranged to image the touch side; and

an illumination unit configured to illuminate the touch side of the touch surface, the illumination unit configured to illuminate separately a) a relatively thin first volume close to the touch surface for touch control of the user interface, and b) a relatively deep second volume extending away from the first volume for three-dimensional hand or body gesture control of the user interface, the separate illuminating providing for separate imaging by the cameras of the first volume and the second volume.

In an embodiment, the plurality of cameras comprises a grid of cameras placed on the internal side of the touch surface and arranged to image through the touch surface.

In an embodiment, the grid is arranged such that points in the second volume are imaged respectively by two cameras, thereby to provide three-dimensional tracking.

In an embodiment, the touch surface is part of an electronic display screen.

In an embodiment, the electronic display screen comprises an LCD screen.

In an embodiment, the illumination unit comprises at least one illumination lamp pointing towards the first volume and at least one illumination lamp pointing towards the second volume.

In an embodiment, the illumination lamps are of a first predetermined wavelength range, the cameras being configured to image at the predetermined wavelength range.

In an embodiment, the touch surface is part of an LCD screen, the LCD screen having illumination light guides for illuminating the LCD screen using a second predetermined wavelength range, and the cameras are constructed to image across the illumination light guides, the first and second predetermined wavelength ranges being non-overlapping.

In an embodiment, the illumination light guides comprise openings transparent to light at the first predetermined wavelength range on a side towards the LCD screen, the cameras being mounted opposite the openings to image through the openings.

According to a second aspect of the present invention, there is provided an LCD screen having an internal side and a viewing side, and light guides on the internal side for illumination of the LCD screen at a first predetermined wavelength range, a grid of cameras being mounted on the light guides to image at a second predetermined wavelength range through the light guides towards the viewing side.

In an embodiment, the light guides have openings transparent to the second predetermined wavelength range, the cameras each being mounted opposite respective ones of the openings.

In an embodiment, the light guides comprise distorting structures, the cameras and openings being located between respective ones of the distorting structures.

In an embodiment, the light guides further comprise built in lens structures located opposite the openings to focus light onto respective cameras.

In an embodiment, the light guide comprises a phosphor surface and the openings are transparent openings for the wave length used by the cameras in the phosphor surface.

An embodiment may further include an illumination unit, configured to illuminate separately a) a relatively thin first volume close to the LCD screen for touch control, and b) a relatively deep second volume extending away from the first volume for three-dimensional hand or body gesture control, the separate illuminating providing for separate imaging of the first volume and the second volume.

According to a third aspect of the present invention there is provided a grid of cameras and a screen, the grid of cameras being arranged to image a volume through the screen, the grid of cameras being spaced a predetermined distance behind the screen and the cameras of the grid being configured with predetermined fields of view, the predetermined distance and the fields of view being selected together to provide that any given point in the volume is within the fields of view of at least two of the cameras, thereby to provide three-dimensional imaging of the volume.

The screen may have illumination light guides, the cameras of the grid being located on the light guides, the light guides configured to illuminate the screen at a first predetermined wave band, and the cameras configured to image through the screen at a second predetermined wave band.

The light guides may, as before, have openings transparent to the second predetermined wavelength range, the cameras each being mounted opposite respective ones of the openings.

The light guides may comprise distorting structures, the cameras and openings being located between respective ones of the distorting structures, and/or built in lens structures located opposite the openings to focus light onto respective cameras.

Alternatively the light guide comprises a phosphor surface and the openings are openings in the phosphor surface.

According to a fourth aspect of the present invention, there is provided a light guide for an LCD screen, the light guide configured to illuminate the LCD screen with light of a first predetermined wavelength band, the light guide comprising a plurality of openings transparent to light at a second predetermined wavelength band.

The light guide may include a phosphor coating around an external wall thereof, the transparent openings being transparent to a specific wave length in the phosphor wall, or may comprise obstructions for diffusing light of the first predetermined wavelength band, the openings being located in between respective pairs of the obstructions, and/or lens structures located in association with the openings, for focusing of light from the openings to imaging cameras mounted opposite the openings.

According to a fifth aspect of the present invention there is provided a method of combining touch and three dimensional depth tracking into a user interface comprising:

at a touch surface:

illuminating an area immediately adjacent to the touch surface with a surface illumination;

carrying out imaging of the touch surface under the surface illumination;

illuminating a volume extending to a depth from the touch surface with a depth illumination;

carrying out imaging of the volume under the depth illumination such that any given point in the volume is imaged from at least two different locations.

The method may comprise carrying out the imaging from behind the touch surface.

The method may comprise illuminating the volume from different sides alternately.

The method may comprise defining a trigger action to allow a user to trigger user interface reaction from the depth tracking.

The method may comprise tracking hands by identifying potential palms in a reduced resolution version of the imaging of the depth volume, then increasing resolution to find potential fingers, and identifying as hands structures coherent between different imaging locations in which palms and fingers are connected.

The method may comprise tracking hands by attempting to fit a three-dimensional model of a hand to imaging data of the depth volume.

The method may comprise varying illumination between imaging frames and using the varied illumination to track 3D structure.

The method may comprise tracking objects in the three dimensional volume using a method of absolute positioning and a method of relative positioning, and alternating between the absolute and the relative positioning to optimize between accurate location and efficiency of calculation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a perspective view of a combined touch and 3D depth user interface with cameras inside the screen and LEDs external to the screen according to an embodiment of the present invention;

FIG. 2A is a simplified diagram showing a light guide for an LED screen designed to accommodate forward facing cameras for imaging through the screen according to an embodiment of the present invention;

FIG. 2B is a simplified diagram of a variation of the embodiment of FIG. 2A in which lens structures are built into the light guide;

FIG. 2C is a simplified diagram showing a further variation of the light guide of FIG. 2A in which openings are provided in a phosphor coating;

FIG. 3 is a perspective view of a combined touch and 3D depth user interface with cameras and LEDs both on the external side of the screen according to an embodiment of the present invention;

FIG. 4 is a perspective view of a combined touch and 3D depth user interface with both cameras and LEDs internal to the screen according to an embodiment of the present invention;

FIG. 5 is a perspective view of a combined touch and 3D depth user interface with cameras inside the screen and LEDs outside the screen according to an embodiment of the present invention;

FIG. 6 is a perspective view of a combined touch and 3D depth user interface further comprising mirrors installed within the depth of the screen structure between the cameras and the screen surface to reduce edge effects, according to an embodiment of the present invention;

FIG. 7 is a perspective view of a system with an acrylic light guide on the screen to enhance separation between touching and 3D imaging;

FIG. 8 is a perspective view of a combined touch and 3D depth user interface according to an embodiment of the present invention, illustrating schematically how the system can be used to scan documents;

FIG. 9 is a perspective view of a combined touch and 3D depth user interface built as a stand-alone device without a display screen and only used to capture the touch and 3D movements, and thus not requiring screen illumination;

FIG. 10 is a simplified flow chart illustrating the separate processing of the touch and depth imaging according to an embodiment of the present invention;

FIG. 11 is a simplified flow chart of a first step of a 3D tracking algorithm in which palm location is tracked, according to an embodiment of the present invention;

FIG. 12 is a simplified flow chart of a second step of the 3D tracking algorithm of FIG. 11, where the fingers and stylus for each palm are tracked;

FIG. 13 is a simplified diagram illustrating tracking of the angle of a stylus when drawing on the screen, according to an embodiment of the present invention; and

FIG. 14 is a simplified diagram showing the ability of the present embodiments to distinguish between one hand with two fingers and two hands with one finger each.

### DESCRIPTION OF SPECIFIC EMBODIMENTS OF THE INVENTION

The present invention, in some embodiments thereof, relates to an object tracking system and method and a user interface using the same, and, more particularly, but not exclusively, to touch control surfaces and to three-dimensional tracking volumes.

The present embodiments provide an infrastructure that allows for a user interface based on touch over a surface and gesture or movement over a three dimensional volume extending from the surface. Both touch and volume tracking may be carried out by the same infrastructure. The tracking may be optical and in one embodiment, the tracking is carried out through the screen by placing cameras within the screen. In another embodiment the cameras are placed in conventional locations around the outside of the screen.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

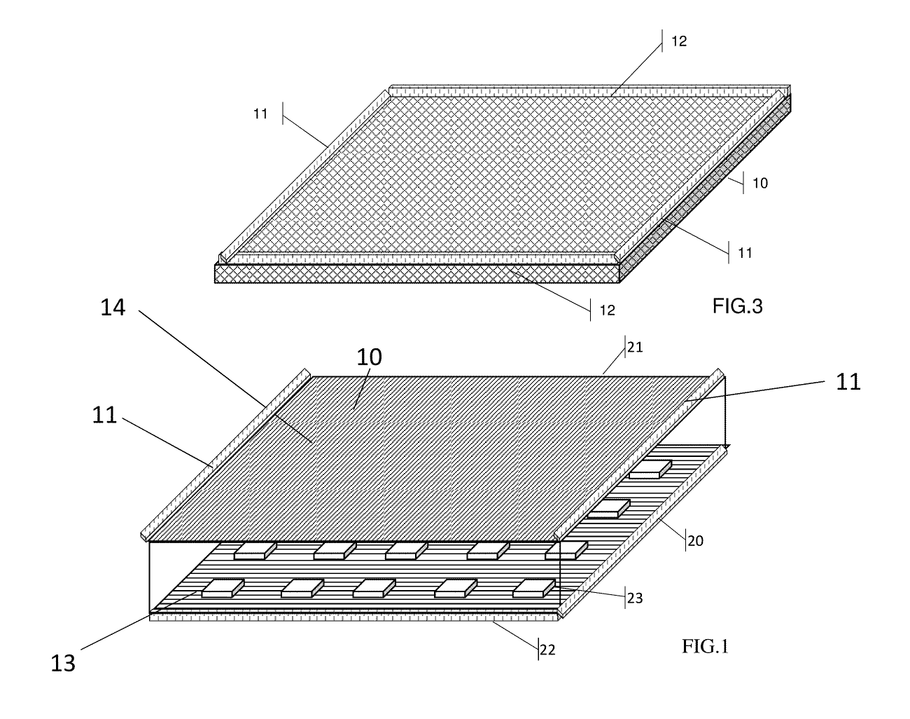

Referring now to the drawings, FIG. 1 is a simplified block diagram showing a user interface apparatus for a computer system, according to a first embodiment of the present invention, comprising a touch surface 10 having an internal side 13 and an external side 14. An illumination unit 11 comprises lamp fittings on one or more edges of the touch surface 10. Here the illumination unit is shown on the external side 14 of the touch surface but as will be discussed elsewhere it may be located on the internal side instead, or partially internally and partially externally. A grid of cameras is placed in the internal side 13 of the touch surface to image through the touch surface.

Regardless of where the illumination unit 11 is placed, the illumination unit 11 illuminates the external side 14 of the touch surface. The illumination unit may separately illuminate two different volumes. The first volume is a relatively thin volume close to the touch surface, and when the first volume is illuminated, the cameras can track objects at the touch surface and thus provide optically supported touch control for the user interface. The second volume to be illuminated is a relatively deep volume extending away from the touch surface and the first volume. When the second volume is illuminated, the same cameras in the same grid are able to track hands and fingers and other objects in the volume for gestures and the like, to give three-dimensional hand or body gesture control for the user interface. The illumination is typically uniform illumination, and three-dimensional information is obtained as a result of each point in the second volume being imaged by at least two cameras.

The illumination unit may time multiplex between the two volumes so that the cameras are able to separately track surface and depth objects with no ambiguity between them.

In a further embodiment, the illumination unit may light the volume in different ways in different frames. Thus in a first frame, the volume may be illuminated from the left and in a second frame from the right, in order to use the contrasts to further enhance the 3D information.

An advantageous side effect of having cameras behind the screen is that they can be used for video conferencing and the like and allow the user to be photographed looking at the camera. In conventional systems the user looks at the screen and appears to the camera to be looking down, creating an unnatural effect.

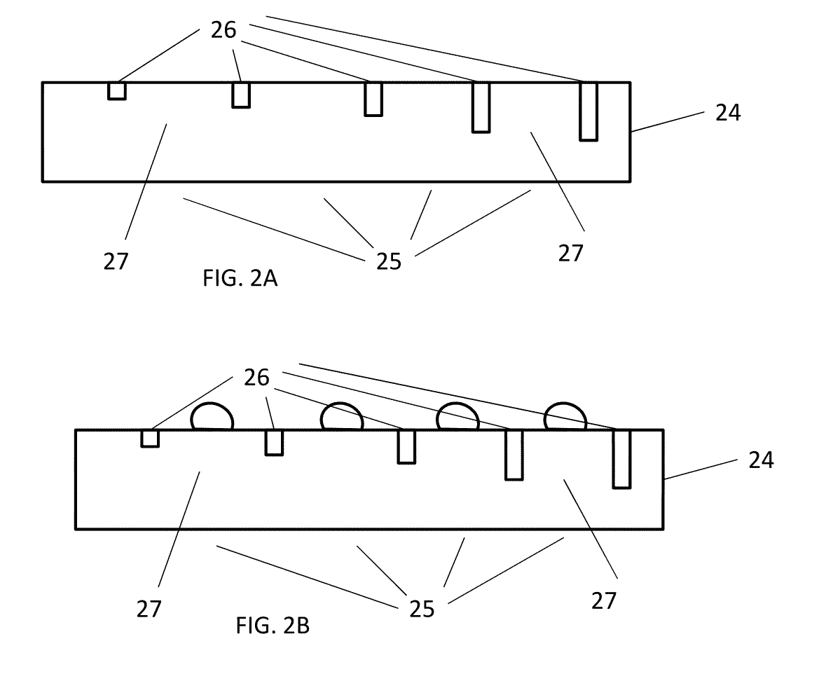

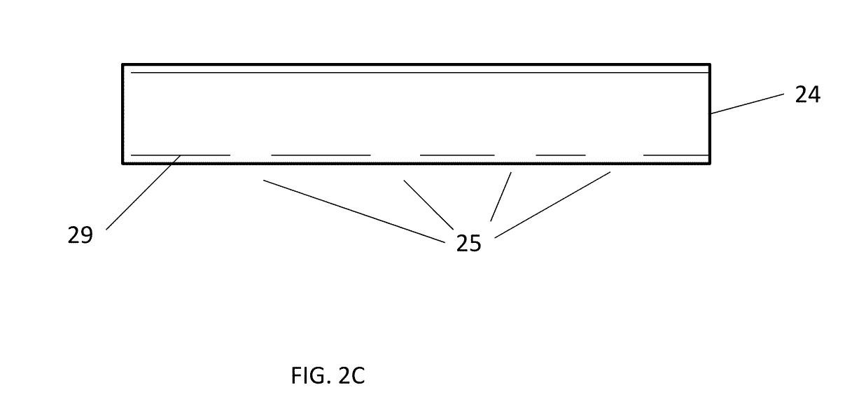

FIG. 1 further shows an exemplary grid arrangement of the cameras 23. Further details of FIG. 2 are discussed in greater detail below. The grid may be arranged such that any given points in the second, depth, volume are imaged respectively by two cameras, thereby to provide three-dimensional tracking. Each camera has a preset field of view, and is located a fixed distance from the surface. The distance and field of view can be calculated together to ensure that any point in the depth volume is within the field of view of at least two of the cameras in the grid.

In an embodiment, the touch surface may be part of an electronic display screen, such as part of an LCD screen. The illumination unit may use illumination lamps, of which one or more point towards the first, surface, volume and one or more illumination lamps point towards the second volume. The illumination lamps may be LED lamps. The illumination lamps may illuminate at a specific imaging wavelength range or band, and the cameras may be filtered to specifically image at that wavelength range. For example the LED lamps may use the near infra-red (NIR) band.

Reference is now made to FIG. 2A, which is a simplified schematic diagram showing a light guide 24 for illumination of an LCD screen. An LCD screen requires screen illumination and has multiple illumination light guides for illuminating the LCD screen using its own wavelength range, typically that of white light. The cameras may be constructed to image across the illumination light guides, and one way to do so is to ensure that the two wavelength ranges are non-overlapping. That is to say the imaging wave band and the screen illumination wave band do not overlap, so that the illumination light in the light guides can simply be filtered out by the cameras thus providing the necessary dark chamber.

The illumination light guides may comprise openings 25 which are transparent to light at the imaging wavelength range. The openings are located on one side of the light guide, which side is positioned towards the LCD screen. The cameras may then be mounted opposite the openings to image through the openings.

As discussed, the LCD screen has an internal side and a viewing side, and the light guides, such as light guide 24, are arranged on the internal side for illumination of the LCD screen using white light. Then, a grid of cameras 23 (in FIG. 1) may be mounted on the light guides to image at the imaging wavelength range through the light guides towards the viewing side. The cameras may each be mounted opposite one of the openings 25.

As shown in FIG. 2A, the light guides comprise distorting structures 26, whose purpose is to diffuse light from the light guide in the direction of the LCD screen. A light source is located at one end of the light guide, which is consequently brighter, so that only a little distortion is needed to divert sufficient illumination to the screen. Further away from the light source the distortion structures get larger as the light flux within the light guide is reduced. The cameras and openings 25 may be located in gaps 27 between the distorting structures 26.

As shown in FIG. 2B, the light guides may comprise built in lens structures 28 which may be located opposite the openings 25 to focus light onto respective cameras. The use of built in lenses has an advantage in making it easier to correctly align the cameras to the openings.

Reference is now made to FIG. 2C, which shows a variation of the light guide in which a fluorescent effect is used. The surface has a phosphor coating 29, and the openings 29 are openings in the phosphor coating. A light source with corresponding wave length fitting the specific phosphor is located behind the coating and activates the phosphor to generate white light.

As discussed, embodiments use an imaging illumination such as IR and then use cameras to obtain radial information of objects in the imaging volume from the imaging illumination returned from the object both on the screen surface and in the depth volume in front the screen. The method may use any number of cameras in a grid but each point in the depth volume may be in the field of view of at least two cameras in order to obtain depth information. The illumination may be any kind of radiation but should be in a specific band. An example is IR provided by IR LED lamps and specific embodiment uses NIR at 850 nm for simple implementation. The cameras may be sensitive to the selected illumination that is used.

A number of different exemplary and non-limiting embodiments are now discussed concerning how to apply the illumination and regarding the structural layout of the cameras and LEDs etc. In these embodiments the illumination is used to light the area at the surface of the screen and the depth volume beyond, typically up to a distance of a meter or two. The cameras may then be used to capture images and track objects from the same area using the imaging wavelength.

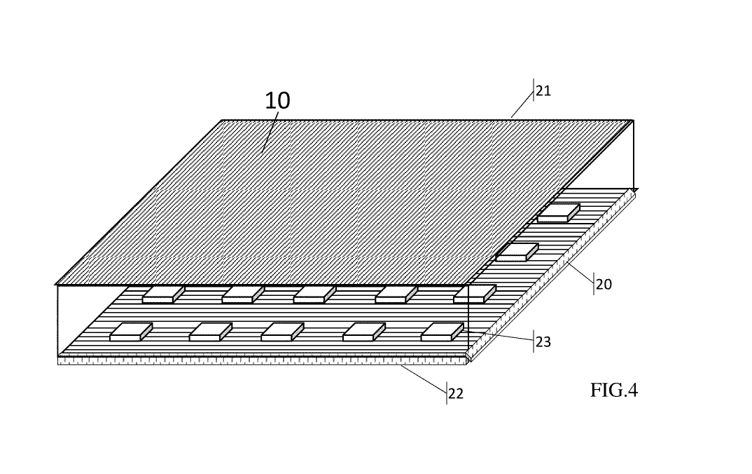

Reference is now made once again to FIG. 3. In the embodiment of FIG. 3, both LEDs and cameras are located on the external side of the screen. In FIG. 3, the screen 10 has internal electronics which house the screen's illumination and the LCD panel as known in regular LCD screens. LED lamps 11 for imaging illumination are located on two opposite edges of the external side of the screen, above the LCD panels. The LED lamps may be located on two or four of the screen edges. The cameras 12 are likewise installed on external edges of the screen, above the LCD panels, on two or four sides.

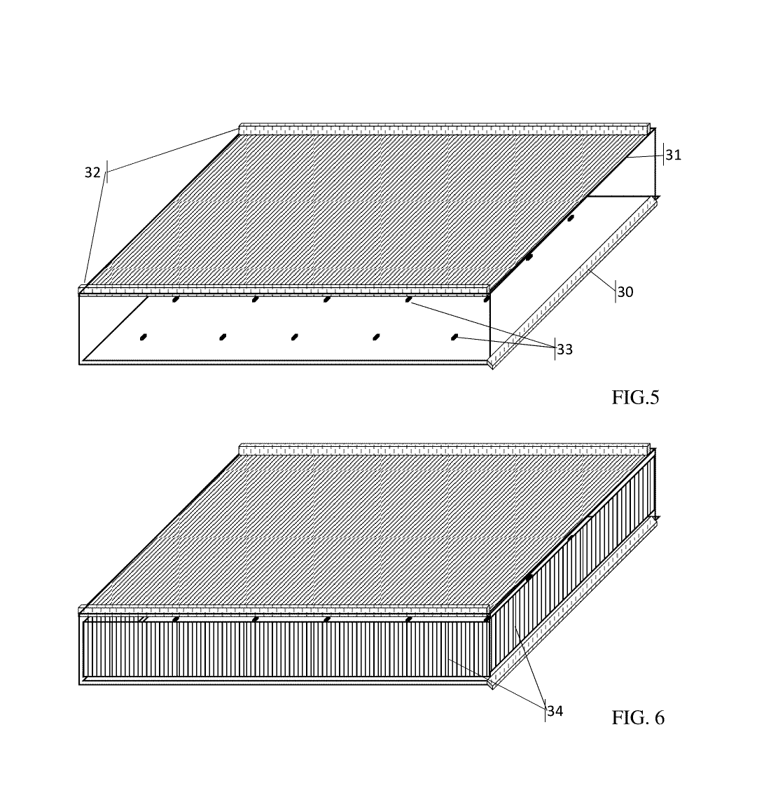

Reference is now made to FIG. 4, which illustrates an alternative embodiment, in which the LED lamps are placed inside the screen as part of the normal illumination of the screen and the cameras are placed between the light guide and the LCD panel. In FIG. 1, the LCD panel 21 is located at a distance from the screen illumination system 20, which contains visible light LED lamps and a light guide. The LEDs 22 are also installed along the light guide and may transmit the light to the screen. Cameras 23 are installed on the light guide and the distance between them is preferably such that every voxel on the surface of the screen is covered by at least two cameras, as discussed. The cameras may be small cameras so as not to be visible while the screen is operating, and pinhole cameras are used in one embodiment.

Reference is now made to FIG. 5, which is a simplified diagram showing a further alternative according to the present embodiments. An option is to install the LEDs outside the screen 31 and the cameras under the light guide, inside the screen. In FIG. 5, the LEDs 32 are installed on two or four sides outside the screen and the cameras 33 are equipped with pinhole lenses and installed under the light guide 30. In order to reduce effects due to light guide interference, the construction can be designed so that the cameras are physically located away from areas of interference, or the cameras may filter out the wavelengths that the light guide uses for illumination.

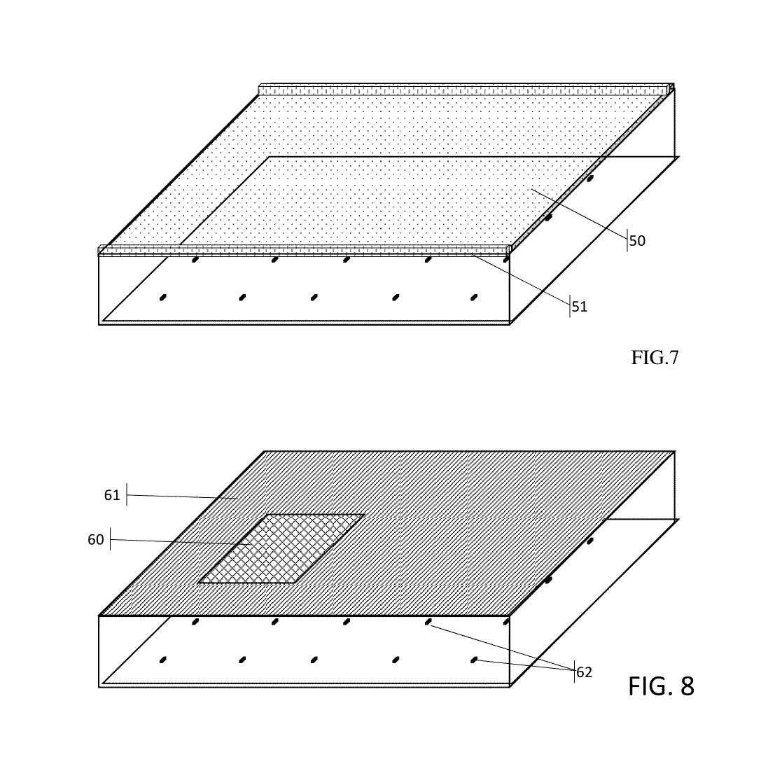

In some constructions of LCD screens there may be a relatively large gap between the screen light source and the screen panel. In such a case, in order to simulate an infinite light source that is bigger than the actual light guide panel, a set of mirrors, for example, may be used on the outer screen boundary to simulate an infinite light source. In FIG. 6, four mirrors 34 are located around the edge boundary of the screen, filling the gap between the light source and the screen panel.

In a variation of the embodiment of FIG. 6 the depth of the light guide completely coverings distance from the cameras to the LCD, so that the mirrors become optional, depending on the exact construction.

Reference is now made to FIG. 7, which illustrates a further embodiment of the present invention. In order to get good separation between surface touch and 3D movement, one option is to add a second set of LEDs together with a transparent acrylic light guide in front of the screen. In FIG. 5, the transparent acrylic light guide 50 is placed on top of the screen panel and the LEDs 51 are on both sides of the acrylic light guide. In this setup, the cameras may capture at double frame rate and the different LED sets are turned ON and OFF in succession during each frame so each frame is separately from only one of the surface light and the area light.

In the event that the setup of the cameras is inside the screen looking outside, the system may also be used to scan documents that are placed on the screen. In FIG. 8, a document 60 is placed on screen 61 and cameras 62 capture and scan the content. Cameras 62 capture the document and build a mosaic which is the scan of the document. In other cases, the system can also scan 3D objects that are placed on the panel by using data from multiple cameras.

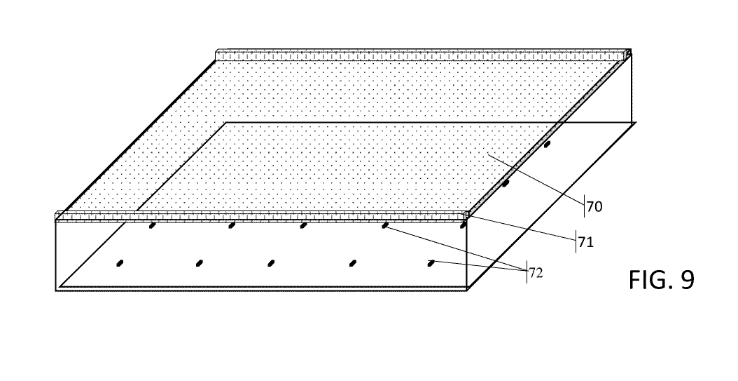

The system can also be installed without the need for an electronic display screen. The surface may be kept blank and serve as a 3D control pad for a suitable application or system based on a remote or local device. Referring now to FIG. 9, cameras 72, LEDs 71 and acrylic light guide 70 are all setup without a screen or for that matter any visible light illumination infrastructure for the screen.

As discussed, the system may contain any number of cameras from two upwards depending on the size of the screen, and the number of cameras may extend to the hundreds and beyond. The number of cameras is partly determined by the thinness of the screen, and by the size of the volume to be tracked. The thinner the screen the smaller the field of view of each camera at the screen surface so the more cameras are needed to cover the surface.

The system may be designed in a modular structure, and there may be a basic assembly module comprising cameras and pre-processing electronics. Then screens of any size can be constructed simply by connecting modules one to another. The pre-processing module may implement algorithms that are relevant only to the cameras on the same module and a mail processing part may handle the overall algorithm to combine all the different cameras from all the modules.

The videos from the cameras may be collected at a central processing unit. The video may be collected via any available means (e.g. USB, Ethernet or LVDS signaling from the cameras). The processing unit may convert the videos from multiple cameras into tracking data of the hands, fingers stylus etc. The system may use dedicated hardware integrated in the screen such as FPGA, ASIC or other devices or may collect the video to an external unit, such as a computer, and perform the video manipulation externally.

After system assembly, there is a process of camera calibration. The calibration may for example use a chess board, but any other method that gives internal and external parameters for each camera in the system with a reference to the first camera may be used. An example of the calibration process is described in the book “Multiple View Geometry in Computer Vision” by Richard Hartley, Andrew Zisserman (Cambridge University Press, 2003).

The processing unit is responsible for converting the video signals from all the cameras to a tracking view of multiple objects in the tracking area. The cameras capture the frames with a synchronized trigger so that all the frames capture the objects at exactly the same time. As discussed above, there is an embodiment that takes one frame when only the surface illumination is on and one frame when only the upper illumination is on. In such an embodiment, half of the frames may give tracking information of screen touching and half of the frames may give tracking information of the 3D movements in the tracking area.

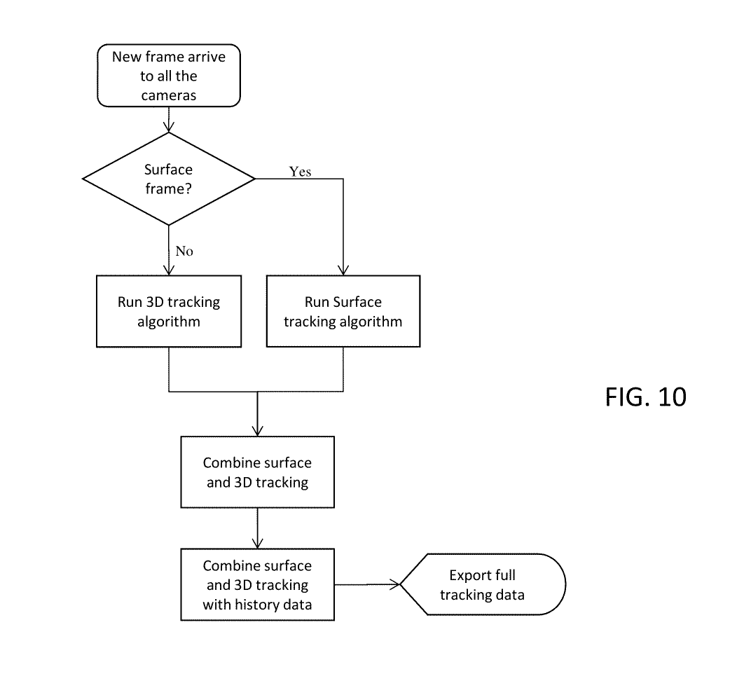

Reference is now made to FIG. 10, which is a simplified flow chart showing operation of the tracking system of the present embodiments. The cameras all take an image frame in synchronized fashion. Once a frame is taken at all the cameras, a tracking algorithm differentiates between frames coming from the surface, that is frames taken when the surface illumination was on, and frames coming from the 3D area, that is frames captured when the 3D tracking illumination is on. In the absence of surface illumination, the system may operate with 3D tracking alone and vice versa. In any case, after the frame has been processed, the information gathered is combined with history information to clean noise and to export more coherent tracking data.

An algorithm for surface tracking may be based on comparing the frame to the background and the previous frame. One example of implementation of such an algorithm is described in International Publication No. WO2010116308. The output of the process comprises different blobs on the surface where it is suspected that there was a touch on the screen.

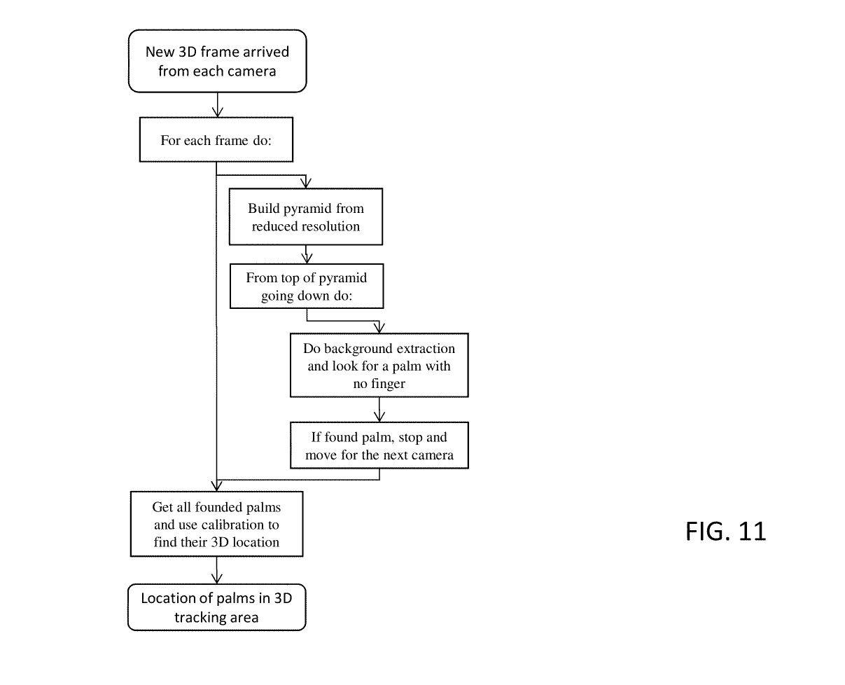

An algorithm for the 3D tracking comprises using the video from all the cameras to find the location of the hands, that is the palm and fingers, and a stylus if present. FIG. 11 shows a possible implementation for the first part of the 3d tracking algorithm. For each 3D frame as it arrives from all the various cameras, the system builds a reduced resolution pyramid to a level at which the fingers are not visible but the palm is visible. For each pyramid, the system searches for a potential palm in the top layer, where the palm is a small blob, by comparing to the saved background and looking for frame to frame differences. All the potential palms are compared against other cameras with the 3D calibration data and only palms that are shown in 2 or more cameras are consider as a valid palm. The exact location of the palms in the 3D environment may be calculated using crossing of rays from the cameras to the palms (stereo view).

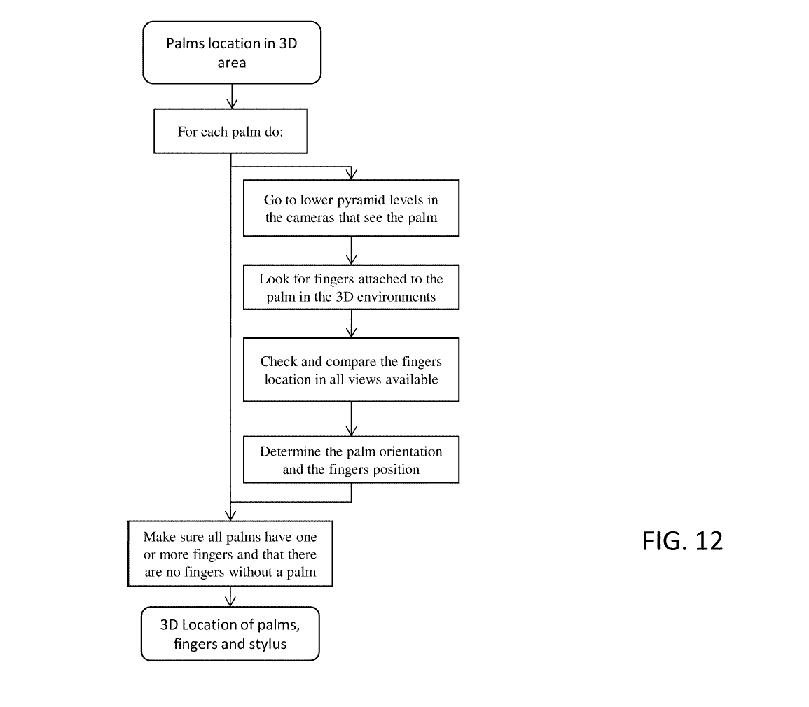

Reference is now made to FIG. 12, which is a simplified diagram illustrating the process once the location of the palms is determined. Once the location of the palms is known, FIG. 12 illustrates a possible process that finds the fingers and\or stylus in the tracking area. The process takes each palm that was located in the previous part and uses the lower level of the pyramid to look for the potential fingers coming out of the palm. The process examines only cameras that see the palm or the potential fingers. Once a finger is found, it is compared using the other cameras that may also see the same finger. Only fingers that are coherent in the fields of view of the different cameras are defined as real fingers or a real stylus. The process also determines the palm orientation according to the fingers. The last part of the process filters out fingers that don't have a palm attached.

The last part of the algorithm involves combining the surface data (if there is any) and the history data from previous frames to generate a logical view of the object to track. For example, a finger that is close to the surface will reach the surface if there is a touch detected at the same location.

The above is an exemplary algorithm. Other algorithms and algorithm classes are available. Three tracking classes involve 1) vectors and curving, 2) fitting of a model of the hand to be tracked, which is initially learned, and then continually fitted into the three dimensional data. 3) Continuity of the successive images.

It is generally assumed that movements in front of the screen are smooth and thus gradual changes are looked for. The basic model fitting may be carried out only occasionally and continuity used to bridge the gaps. In addition, the effect of lighting can be added in to the fitting of the model. Thus the model may be fitted so that particular orientations are expected over the hand. If the lighting source is known then shade can be used as a double check on the fitted model.

The various information sources of absolute positioning, relative positioning and lighting, as well as dynamic change in resolution may be combined in a way that optimizes for minimal calculation effort or for accuracy of tracking. For example a default may be set of relative positioning and then, when movement gets quicker, or more fine, the system may move to absolute positioning. Hand movements are not exact except on a surface so the 3D tracking always needs lower resolution. Further more the faster the hand movement the less precise, so higher speed only needs a lower resolution.

As mentioned, one may change the lighting. Different frames may alternately be lit from one side and then the other to give more information.

If more precise 3D tracking is needed on a sharp-ended stylus, a multi-directional reflector and/or a target based on a pre defined pattern can be used on the end of the stylus to enhance the reflection of the illumination. The cameras may then better see the point and the algorithm can calculate its 3D location more accurately.

Once the 3D tracking information is available a further application may convert the tracking into interface interactions. There are many different implementations that can use the 3D track instead of the regular 2d tracking.

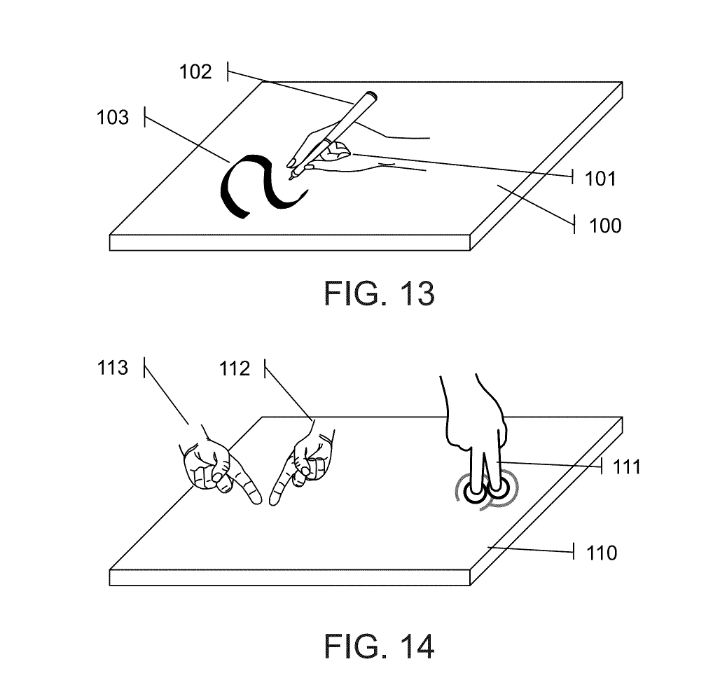

Reference is now made to FIG. 13, which shows tracking of the angle of the stylus 102, or for that matter a finger, in reference to the tracking surface 100. The 3D tracking sees the upper end of the stylus, not just the point that touches the screen and not only the location of the palm 101. The additional information can be used to enhance the point location information so that for example a virtual drawing can use the information to vary line thicknesses or texture in virtual drawings 103. Such information is useful in art, design, security and more.

Reference is now made to FIG. 14, which illustrates the use of 3D information to distinguish between two fingers of the same hand touching the screen 111, and fingers from each of two different hands 112+113 on the surface 110.

The system may provide 3D mouse control over a cursor on the surface and also above the surface. The applications for a 3D mouse may include architecture and mechanical design, both of which require accurate control of a z dimension into depth of a virtual drawing. The 3D mouse can also be used in gaming to control flight, drive and such.

If the user wants to see a 3D cursor that matches the tracking, he can use one of the following: a 3D monitor that moves the video of the screen and the cursor location so it appears as realistic 3D. If the graphics and tracking extend outside the limits of the screen, the use of personal video glasses can give the user the ability to see feedback on their movement in space by providing augmented reality.

3D tracking may be disabled in some parts of the operation and be active only when 3D control is needed. In order to trigger 3D tracking many methods can be used such as touching a special area on the surface of the screen, a special movement or predefined gesture on the surface or on the 3D area distinguished by speed and direction, integration with voice or any combination of the above.

The cameras as described are currently used for “close” 3D tracking but can also be used as a far 3D tracking system simply by changing the focal lengths on the cameras and increasing the power of the illumination. Alternatively the system can be enhanced with an existing far 3D tracking system. Whichever of the two approaches is used, the result may be continuous tracking of the person at distance together with tracking of the hands and fingers from close-up. The far tracking can determine that someone is approaching the screen and may prime the system ready for close tracking based on their exact location.

It is expected that during the life of a patent maturing from this application many relevant imaging technologies and screen technologies will be developed and the scope of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. User interface apparatus for a computer system, comprising:
a touch surface having an internal side and a touch side;
a plurality of cameras placed about said touch surface and arranged to image said touch side; and
an illumination unit configured to illuminate said touch side of said touch surface, said illumination unit configured to illuminate separately a) a relatively thin first volume close to said touch surface for touch control of said user interface, and b) a relatively deep second volume extending away from said first volume for three-dimensional hand or body gesture control of said user interface, said separate illuminating providing for separate imaging by said cameras of said first volume and said second volume.

2. The user interface apparatus of claim 1, wherein said plurality of cameras comprises a grid of cameras placed on said internal side of said touch surface and arranged to image through said touch surface, wherein said grid is arranged such that points in said second volume are imaged respectively by two cameras, thereby to provide three-dimensional tracking.

3. (canceled)

4. Apparatus according to claim 1, wherein said touch surface is part of one member of the group consisting of an electronic display screen and an LCD screen.

5. (canceled)

6. Apparatus according to claim 1, wherein said illumination unit comprises at least one illumination lamp pointing towards said first volume and at least one illumination lamp pointing towards said second volume, wherein said illumination lamps are of a first predetermined wavelength range, said cameras being configured to image at said predetermined wavelength range.

7. (canceled)

8. Apparatus according to claim 6, wherein said touch surface is part of an LCD screen, said LCD screen having illumination light guides for illuminating said LCD screen using a second predetermined wavelength range, and said cameras are constructed to image across said illumination light guides, said first and second predetermined wavelength ranges being non-overlapping.

9. Apparatus according to claim 8, wherein said illumination light guides comprise openings transparent to light at said first predetermined wavelength range on a side towards said LCD screen, said cameras being mounted opposite said openings to image through said openings.

10. An LCD screen having an internal side and a viewing side, and light guides on said internal side for illumination of said LCD screen at a first predetermined wavelength range, a grid of cameras being mounted on said light guides to image at a second predetermined wavelength range through said light guides towards said viewing side.

11. The LCD screen of claim 10, wherein said light guides have openings transparent to said second predetermined wavelength range, said cameras each being mounted opposite respective ones of said openings, wherein the light guides comprise distorting structures, the cameras and openings being located between respective ones of said distorting structures.

12. (canceled)

13. The LCD screen of claim 11, wherein the light guides further comprise built in lens structures located opposite said openings to focus light onto respective cameras, or wherein said light guides comprises a phosphor surface and said openings are transparent openings for the wave length used by the cameras in said phosphor surface.

14. (canceled)

15. The LCD screen of claim 10, further comprising an illumination unit, configured to illuminate separately a) a relatively thin first volume close to said LCD screen for touch control, and b) a relatively deep second volume extending away from said first volume for three-dimensional hand or body gesture control, said separate illuminating providing for separate imaging of said first volume and said second volume.

16. The apparatus of claim 1, wherein said cameras are arranged in a grid, and said touch surface is part of a screen, the grid of cameras being arranged to image a volume through said screen, the grid of cameras being spaced a predetermined distance behind said screen and the cameras of said grid being configured with predetermined fields of view, said predetermined distance and said fields of view being selected together to provide that any given point in said volume is within the fields of view of at least two of said cameras, thereby to provide three-dimensional imaging of said volume.

17. The apparatus of claim 16, the screen having illumination light guides, the cameras of said grid being located on said light guides, the light guides configured to illuminate said screen at a first predetermined wave band, and said cameras configured to image through said screen at a second predetermined wave band, wherein said light guides have openings transparent to said second predetermined wave band, said cameras each being mounted opposite respective ones of said openings, and wherein the light guides comprise distorting structures, the cameras and openings being located between respective ones of said distorting structures.

18-19. (canceled)

20. The apparatus of claim 17, wherein the light guides further comprise built in lens structures located opposite said openings to focus light onto respective cameras, or wherein the light guides comprise a phosphor surface and said openings are openings in said phosphor surface.

21-22. (canceled)

23. The LCD screen of claim 10, wherein at least one of the light guides is configured to illuminate said LCD screen with light of a first predetermined wavelength band, the light guide comprising a plurality of openings transparent to light at a second predetermined wavelength band.

24. (canceled)

25. The light guide of claim 23, comprising obstructions for diffusing light of said first predetermined wavelength band, said openings being located in between respective pairs of said obstructions.

26. (canceled)

27. A method of combining touch and three dimensional depth tracking into a user interface comprising:
at a touch surface:
illuminating an area immediately adjacent to said touch surface with a surface illumination;
carrying out imaging of said touch surface under said surface illumination;
illuminating a volume extending to a depth from said touch surface with a depth illumination;
carrying out imaging of said volume under said depth illumination such that any given point in said volume is imaged from at least two different locations.

28. The method of claim 27, comprising carrying out said imaging from behind said touch surface.

29. The method of claim 27, comprising illuminating said volume from different sides alternately.

30. The method of claim 27, further comprising defining a trigger action to allow a user to trigger user interface reaction from said depth tracking.

31. The method of claim 27, comprising tracking hands by identifying potential palms in a reduced resolution version of said imaging of said depth volume, then increasing resolution to find potential fingers, and identifying as hands structures coherent between different imaging locations in which palms and fingers are connected, or tracking hands by attempting to fit a three-dimensional model of a hand to imaging data of said depth volume, or tracking objects in said three dimensional volume using a method of absolute positioning and a method of relative positioning, and alternating between said absolute and said relative positioning to optimize between accurate location and efficiency of calculation.

32-34. (canceled)
